(19) United States
(12) Patent Application Publication
(10) Pub. No.: US 2015/0287134 A1
(43) Pub. Date: Oct. 8, 2015

(54) Social Banking Information Presentation Methods and Supporting Technical Architecture

(71) Applicant: NAMU SYSTEMS LLC, a Delaware (USA) limited liability company, Mahwah, NJ (US)

(72) Inventor: Piotr D. Budzinski, Sopot (PL)

(73) Assignee: NAMU SYSTEMS LLC, a Delaware (USA) limited liability company, Mahwah, NJ (US)

(21) Appl. No.: 14/678,963

(22) Filed: Apr. 4, 2015

Related U.S. Application Data
(60) Provisional application No. 61/975,219, filed on Apr. 4, 2014.

(51) Int. Cl. G06Q 40/02

(52) U.S. Cl. CPC G06Q 40/02

(57) ABSTRACT

A system for displaying social banking information, searching banking information using partial textual inputs with supportive keywords, and a supporting technical architecture that enables real-time smart association of social data with the banking information. The system comprises at least one computer for storing user transactions, a computer program for organizing these transactions according to various categories, a user interface, and a program product including machine-readable program code. The code, when executed, causes the at least one computer to perform the following process steps: (a) receiving a monetary transaction by a user; (b) capturing an image related to the monetary transaction; (c) associating the image with the monetary transaction; (d) presenting the monetary transaction and the image to the user; and (e) presenting search result options based on a text search by the user.

### CROSS-REFERENCE TO RELATED APPLICATIONS

This application claims the benefit of U.S. Provisional Application No. 61/975,219, filed Apr. 4, 2014.

### BACKGROUND OF THE INVENTION

1. Field of Invention

The present invention relates to methods of displaying banking information and, more particularly, to displaying relevant visuals relating to the banking information, searching banking information using partial textual inputs with supportive keywords, and the supporting technical architecture that enables real-time smart association of social data with the banking information.

2. Background Art

The current banking user interface is un-intuitive and limited by the statement-like format and product centric segregation of information. Most banking customers when reviewing their past transactions, balances, etc. have a hard time reconciling this information which is presented to them as dates, amounts, coded payee names or vendors - with actual life events. Additionally, it is difficult to find specific transactions with simple textual searches like Google search, as searches are pre-scoped to specific bank products - checking accounts, credit cards, loans. So, a user can only search within a product bound and still multiple trial and error searches are required.

There is an inherent disconnect between current banking interfaces and the real life events. These life events are usually recorded in the user's memory as images, sounds or emotions. And a typical human remembers these events such as meals at a restaurant, purchase of gifts, vacation travel as images and emotions rather than dates, amounts, codes.

As can be seen, there is a need for a new method of displaying banking information.

### OBJECTS AND SUMMARY OF THE INVENTION

It is therefore an object of the present invention to overcome the problems associated with conventional methods of displaying banking information.

It is another object of the present invention to provide a method of displaying banking information that is more intuitive than conventional methods.

It is a further object of the present invention to provide a method of displaying banking information that makes it easier for the banking customer to reconcile banking transactions, balances, etc. with actual life events.

It is yet another object of the present invention to provide a method of displaying banking information that enables real-time smart association of social data with the banking information.

It is yet a further object of the present invention to provide a banking information system that displays relevant visuals relating to the banking information.

It is still another object of the present invention to provide a banking information system that includes the capability of searching banking information using partial textual inputs with supportive keywords.

These and other objects are attained in accordance with the present invention, wherein, in one exemplary embodiment, there is provided a system for displaying social banking information, searching banking information using partial textual inputs with supportive keywords, and a supporting technical architecture that enables real-time smart association of social data with the banking information. The system comprises at least one computer for storing user transactions, a computer program for organizing these transactions according to various categories, a user interface, and a program product including machine-readable program code. The code, when executed, causes the at least one computer to perform the following process steps: (a) receiving a monetary transaction by a user; (b) capturing an image related to the monetary transaction; (c) associating the image with the monetary transaction; and (d) presenting the monetary transaction and the image to the user. The process steps may further include: (e) presenting search result options based on a text search by the user.

In another exemplary embodiment of the present invention, there is provided a method of displaying social banking information, searching banking information using partial textual inputs with supportive keywords, and a supporting technical architecture that enables real-time smart association of social data with the banking information. The method comprises the steps of: (a) receiving a monetary transaction by a user; (b) capturing, an image related to the monetary transaction; (c) associating the image with the monetary transaction; and (d) presenting the monetary transaction and the image to the user. The method may further comprise the steps of: (e) searching monetary transactions of the user using partial textual inputs with supportive keywords; and (f) presenting search result options based on the searching conducted in step (e).

### BRIEF DESCRIPTION OF THE DRAWING

Further objects of the present invention will become apparent from the following description of preferred embodiments, with reference to the accompanying drawing, in which:

FIG. 1 is a screen display of a picture-based transaction view, according to the present invention, containing a transaction section and a photo associated with the transaction;

FIG. 2 is a general flow chart diagram outlining an exemplary process of the present invention, concerning a transaction photo-matching algorithm;

FIG. 3 is a screen display of a photo-based accounts view, according to the present invention, containing a photo and checking account balance information superimposed on the photo;

FIG. 4 is a screen display of a photo-based calendar view, according to the present invention, containing a transactions total section and a picture or photo associated with the transactions total section;

FIG. 5 is a screen display of a photo-based beneficiary view, according to the present invention, containing a transactions total section and a photo associated with a beneficiary;

FIG. 6 is a screen display of a photo-based merchants view, according to the present invention, containing a transactions total section and a photo or graphic associated with a merchant;

FIG. 7 is a general flow chart diagram outlining an exemplary process of the present invention, concerning merchant e-commerce transactions and views; and

FIGS. 8A-8F is a series of displays on a mobile phone, as examples of the different photo-based views encompassed by the present invention.

### DETAILED DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for storing, organizing and displaying banking information, comprising: a computer storing user transactions; a computer program organizing these transactions according to various of categorizations; a computer having a user interface; and a program product comprising machine-readable program code for causing, when executed, the computer to perform the following process steps: receiving a monetary transaction by a user; capturing an image related to the monetary transaction; associating the image with the monetary transaction; presenting the monetary transaction and the image to the user; presenting search result options based on the text search by the user.

The present invention includes a method of presenting banking information—a banking user interface that provides a meaningful, intuitive, and engaging representation of transactional data through images rather than amounts and codes that are linked to a user's life events via various social activities of the user referred as ‘Social Banking’. This creates a natural, intuitive and meaningful interface that allows a user to more quickly recall transactions by providing their visual context. These images also bring back positive emotions related to the purpose of specific transactions, thus making banking enjoyable and more human. The interface may also substitute an elaborate menu with a single search field through which the user enters keywords or verbs that allow the user to complete desired actions.

This social banking is enabled through a unique technical architecture solutions largely comprised of database server, application server, cloud server and front-end channel applications such as mobile application etc. It uses services and interfaces available by the bank to integration and uses several replication and synchronization techniques to move data in optimization of the use cases supporting social banking activities.

Referring now to the figures, the listed components are individual screens and actions that provide different views and presentation of visual and textual information as well as particular functions. The screens are part of one application and can be invoked by the user through a touch interface based on need in no particular sequence.

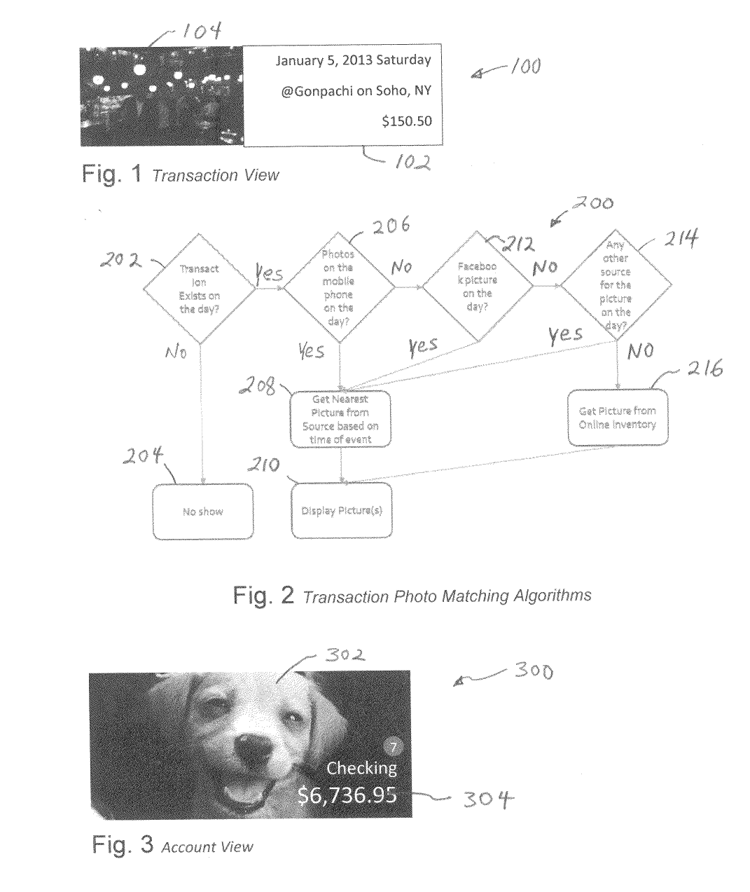

Picture-Based Transaction View—FIG. 1

In FIG. 1, there is shown a screen 100 displaying a picture-based transaction view, containing a transaction section 102 and a photo 104 associated with the transaction. The photo is used to help an individual remember a particular event. It used to be available only for very special event in the analog times. But now it has moved to all digital with the introduction of smart phones with a high quality camera. Many social applications like Facebook®, Pinterest®, and others allow a user to post any pictures of the event. The availability of fast internet networks help a user to be connected all the time to post and get pictures in real time. This trend has begun changing the behavior of the 21c society to use pictures for supplementary communication as well as sometimes a main communication anywhere, everywhere and all the time. This social trend makes almost all the photos a user has taken to be readily available in the internet. Therefore this invention connects the photos of a user via matching algorithms to user's transactions in the bank. Once they are matched, then they can be available for a user to view pictures together with transactions on the banking electronic channels (FIG. 1).

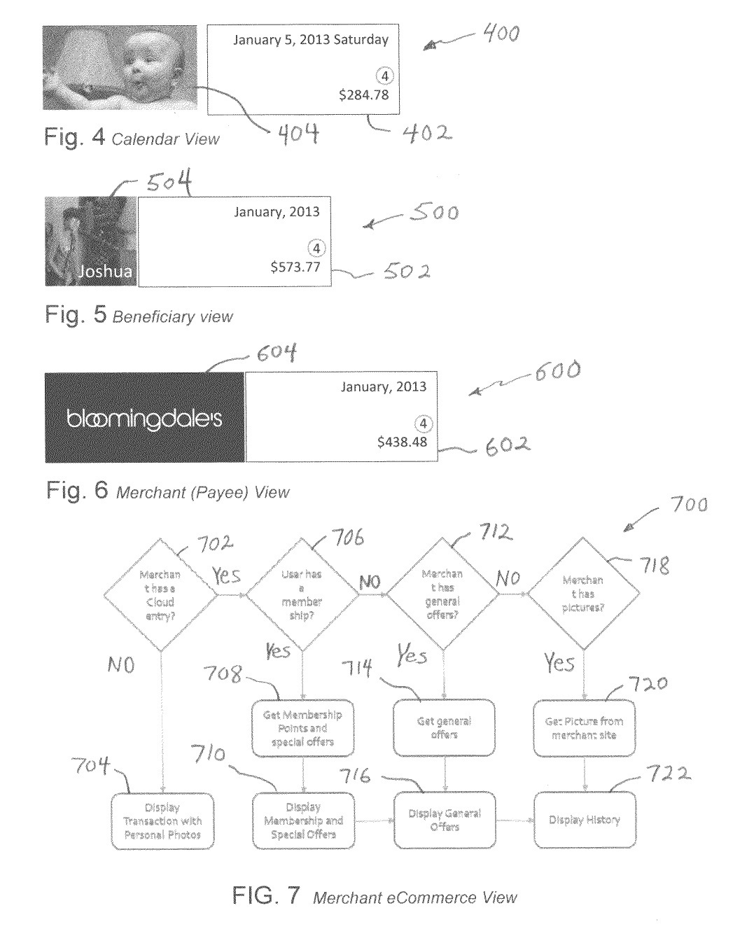

FIG. 2 shows a general flow diagram 200 outlining an exemplary process of the present invention. To begin, a query 202 is made as to whether a transaction by a user existed on a particular day. If not, a display is not generated, as indicated by a “No show” block 204. If a transaction existed on that day, a query 206 is made as to whether a photo exists on the user's mobile phone for that particular day. If it does, a command 208 is issued to get the nearest photo from the source (in this case, from the mobile phone) based on the time of the event (e.g., time of transaction). The retrieved photo is then displayed as represented by a block 210. If a photo does not exist on the mobile phone for that particular day, a query 212 is made as to whether a photo exists on the user's Facebook® account. If it does, command 208 is issued to get the nearest photo from the source (in this case, from Facebook® account) based on the time of the event. The retrieved photo is then displayed as represented by block 210. If a photo does not exist on the Facebook® account for that particular day, a query 214 is made as to whether a photo exists on any other available source of the user for that day. If it does, command 208 is issued to get the nearest photo from the other source based on the time of the event. The retrieved photo is then displayed as represented by block 210. If a photo does not exist on any other available source of the user, a command 216 is issued to get a picture or photo from an online inventory (e.g., library or gallery). The retrieved inventory photo is then displayed as represented by block 210.

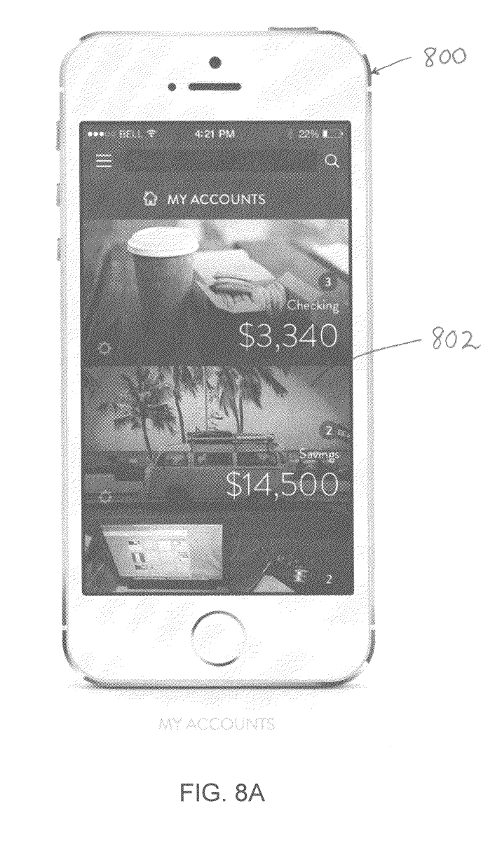

Photo-Based Accounts View—FIG. 3

Referring to FIG. 3, there is shown a screen 300 displaying a photo-based accounts view, containing a photo 302 and checking account balance information 304. Photo 302 could also represent a particular account of a user. Photo 302 could be a default picture from a bank or any picture a user decides to use.

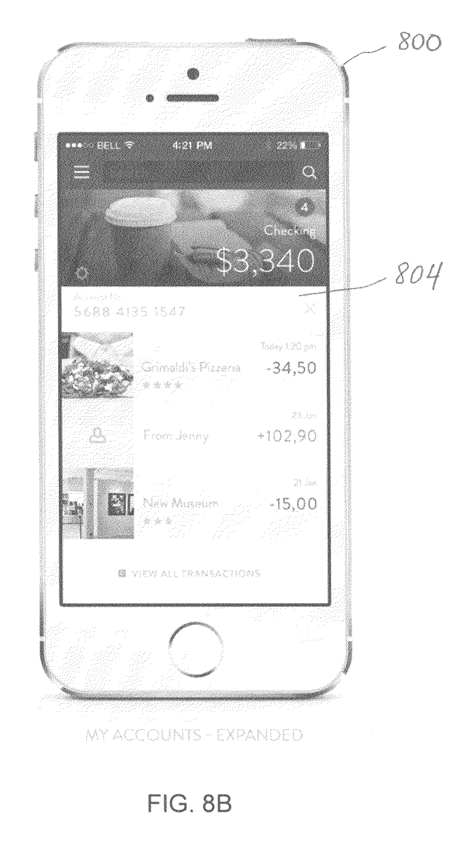

Photo-Based Calendar View—FIG. 4

Referring to FIG. 4, there is shown a screen 400 displaying a photo-based calendar view, containing a transactions total for the day section 402 and a picture or photo 404 associated with section 402. In this example, all transactions can be grouped per calendar date and displayed in sum across different accounts or per account for a user to see a daily total of the transactions. Transactions section 402 is displaying a sum of transactions, across different accounts of the user, for Saturday, Jan. 5, 2013. In this calendar view 400 of the transactions, picture or photo 404 of a date, whether it is a default or from a user's social activity, is then linked and represented in the calendar view.

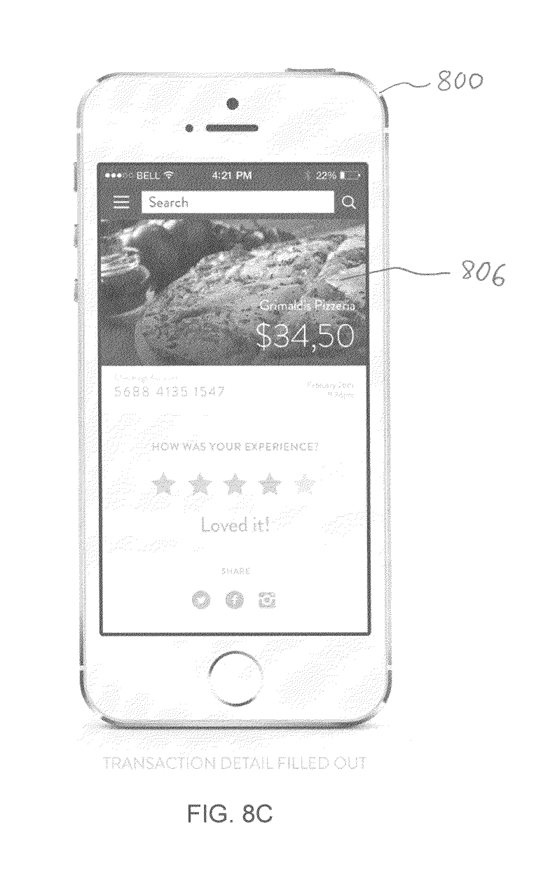

Photo-Based Beneficiary View—FIG. 5

Referring to FIG. 5, there is shown a screen 500 displaying a photo-based beneficiary view, containing a transactions total for the month. section 502 and a picture or photo 504 associated with a beneficiary. A transaction can also be categorized for a beneficiary that a user has a social relationship with, such as family, friends, and colleagues. In FIG. 5, transaction 502 relates to a beneficiary named Joshua, who is depicted in photo 504. An object relationship category could be added that brings a beneficiary relationship to the user such as home, vacation house, car, vacation, etc. So when the payment is made or a payment has just occurred where a user has been notified, a user can select a particular beneficiary for the transaction with this categorization. Total amount can be summed per beneficiary. In that case, a picture of a beneficiary selected shows whom this is for and all aggregation of transactions in the designated timeframe.

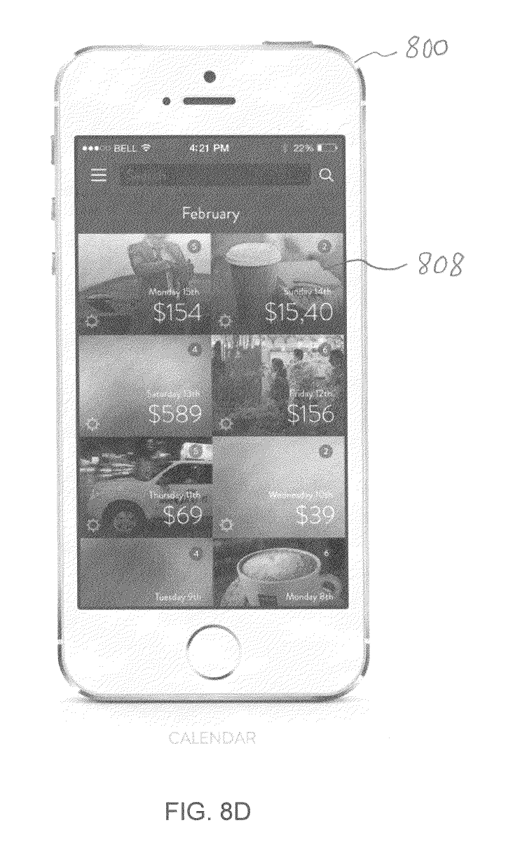

Photo-Based Merchant (Payee) View—FIG. 6

Referring to FIG. 6, there is shown a screen 600 displaying a photo-based Merchant (Payee) view, containing a transactions total for the month section 602 and a photo, picture or graphic 604 associated with a merchant. A transaction can also be categorized under a merchant or a payee. The difference between a merchant (payee) and beneficiary is that the beneficiary does not have a payment relationship directly on the transaction where a merchant or a payee is the other party of the payment transaction. Both of them. (merchant (payee) and beneficiary) could be an organization or an individual. Total amount can be summed per a merchant or a payee. In that case, a picture of a merchant or a payee selected (e.g., photo 604) shows whom this is for and all aggregation of transactions in the designated timeframe (e.g., as shown in section 602). When a merchant has an ecommerce site, an integration could be made for the current invention to present membership and offering via this front-end view of a merchant or a payee.

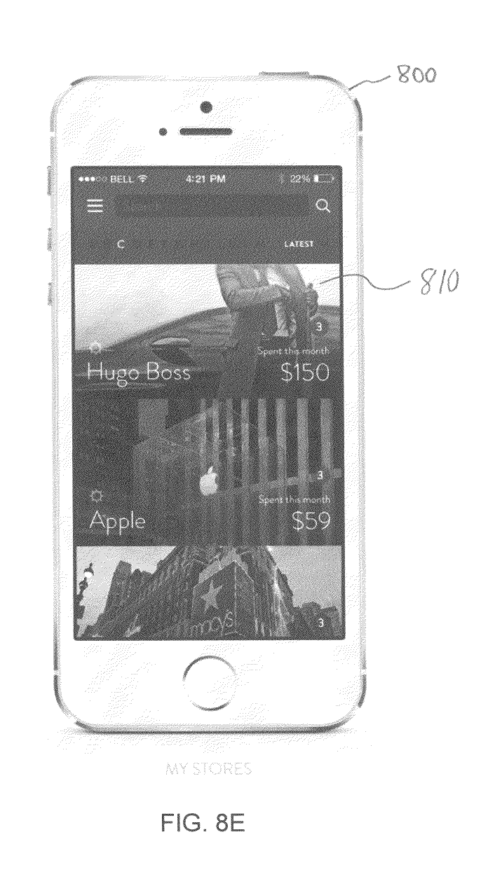

FIG. 7 shows a general flow diagram 700 outlining an exemplary process of the present invention. To begin, a query 702 is made as to whether a merchant has a Cloud entry. If not, a command 704 is issued to display a transaction with personal photos. If the merchant has a Cloud entry, then a query 706 is made as to whether a user has a membership. If the user has a membership, a command 708 is issued to get the user's membership points and any special offers available to the user. This information may then be displayed to the user as represented in a block 710. If the user does not have a membership, a query 712 is made as to whether the merchant has any general offers for the user. If there is a general offer, a command 714 is issued to get the general offer. The general offer may then be displayed to the user as represented in a block 716. Lastly, a query 718 is made as to whether the merchant has pictures. If the merchant has a picture or pictures, a command 720 is issued to get the picture or pictures from the merchant's website. The merchant's picture (or pictures) is then displayed as part of a composite History presentation to the user, as represented in a block 722. The presentation at block 722 may merely display the merchant's picture if the user is not member or the merchant does not have any general offers for the user. However, the presentation at block 722 may contain a display of membership points, special offers, and/or general offers, along with the merchant's picture, if the user has a membership and/or if the merchant has special or general offers.

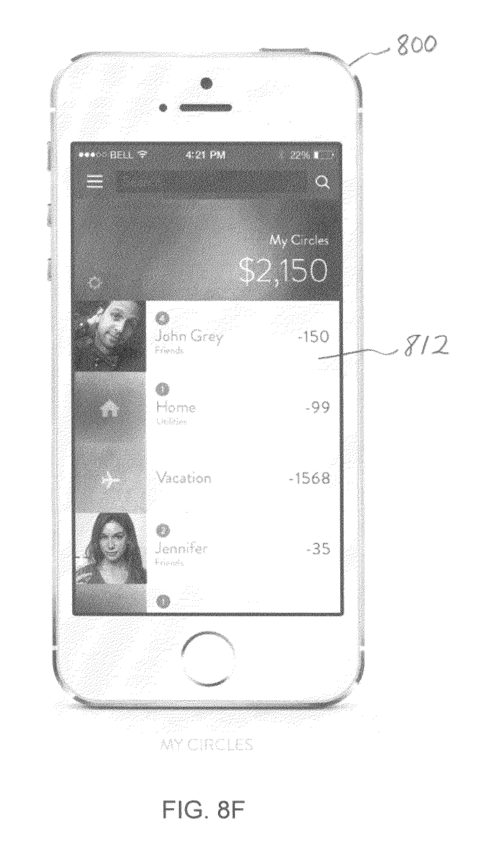

FIGS. 8A-8F show further examples of displays generated on a mobile phone 800 in accordance with the present invention. FIG. 8A shows a photo-based accounts view 802 displayed on phone 800. Accounts view 802 displays a checking account balance together with an associated fast food photo and a savings account balance together with an associated travel or vacation photo. The display of the checking account and the savings account includes a number inside a circle. This number represents the number of new transactions posted to the account since the last viewing. FIG. 8B shows a combination photo-based accounts view and photo-based transaction view 804, displayed on phone 800. View 804 displays a checking account balance (and account number) together with an associated fast food photo and a series of transactions representing a purchase of food from Grimaldi's Pizzeria, a payment received from a person called Jenny, and a payment of an admission fee to a museum. These transactions represent debits and credits to the checking account. As shown, each transaction has a photo or symbol associated with it. FIG. 8C shows another photo-based transaction view 806. In this case, the transaction is superimposed on an associated photo of a pizza. The transaction was a purchase of a pizza using a particular account, the account number of which is shown in view 806. An interface is also presented that enables the user to rate the pizza restaurant.

FIG. 8D shows a photo-based calendar view 808 displayed on phone 800. Calendar view 808 displays the current month—February—and eight consecutive days in February. Preferably, each day is represented by a photo taken on, or otherwise having a relationship to, the day being represented. For each day, the day of the week and the date is displayed together with the photo. Also, on the days where purchases and other expenses were incurred, a total amount of such purchases and expenses is displayed. Further, in the display of each day, there is a number inside a circle, which represents either the number of new transactions posted to the account since the last viewing or the number of transactions represented in the total amount being displayed. FIG. 8E shows a photo-based merchants (payee) view 810 displayed on phone 800. Merchants view 810 includes a display of three merchants, Hugo Boss®, Apple® and Macy's®. For each merchant, the total amount spent for the month with that merchant is displayed together with a photo representing the merchant. Also, the name of the merchant is displayed. For Macy's®, a total is not shown, which means that no expenditures were made with that merchant for the month. Lastly, in FIG. 8F, a photo-based beneficiary or transaction view 812 is displayed on phone 800. The transactions displayed in view 812 are part of a general category referred to as a “My Circles.” View 812 shows expenditures relating to a user's social circle and lifestyle. For example. view 812 shows a beneficiary or transaction view for two friends, Jennifer and John Grey. Each of those views includes a photo of the friend adjacent to the transaction. Two personal categories of transactions are also displayed—home and vacation. A symbol or photo is located adjacent to each personal category of transactions.

Partial Text Search and Completion

The present invention provides a single search field to complete searches that invoke several key actions. Searches can be done based on few characters a user inputs triggering the present invention to search all the historical transaction information of a user and suggest few related search results in real time. Action keyword suggestions/prompts appear during the search for the user to make a quick decision on what action he wants to take. The three verbs are View, Show and Pay and they represent the most frequent banking activities. “View” is used in the case when the search is on account, date, circle, merchant (payee) providing basic summary information and the most recent balances. “Show” is used for providing the most recent transaction list based on the amount. “Pay” represents a transaction initiated by a user. When the account is checking or savings, then it's “Pay From” a particular account. When the account is a credit card, all loans, time deposits, then it becomes “Pay To.” This is triggered when account or payee is searched. Other type of keywords can be added to bring convenience for a user to get to the requested information quickly.

The invention is made by designing a visual user interface and a new and unique banking user experience, developing software algorithms combined in a multi-layered systems consisting of a front-end user interface which is a Mobile or Web Application and a back-end consisting of Application Server, Data Server and Cloud Server and any integration layers in between and among larger legacy systems of a bank.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet, In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What I claim is:

1. A system for displaying social banking information, searching banking information using partial textual inputs with supportive keywords, and a supporting technical architecture that enables real-time smart association of social data with the banking information, comprising:
a computer storing user transactions;
a computer program organizing said transactions according to various of categories;
at least one computer having a user interface; and
a program product including machine-readable program code for causing, when executed, said at least one computer to perform the steps of;
(a) receiving a monetary transaction by a user;
(b) capturing an image related to the monetary transaction;
(c) associating the image with the monetary transaction; and
(d) presenting the monetary transaction and the image to the user.

2. The system of claim 1, wherein the program code of said program product further performs the steps of:
(e) searching banking information using partial textual inputs with supportive keywords; and
(f) presenting search result options based on the searching performed in step (e).

3. A method of displaying social banking information, searching banking information using partial textual inputs with supportive keywords, and a supporting technical architecture that enables real-time smart association of social data with the banking information, said method comprising the steps of:
(a) receiving a monetary transaction by a user;
(b) capturing an image related to the monetary transaction;
(c) associating the image with the monetary transaction; and
(d) presenting the monetary transaction and the image to the user.

4. The method of claim 3, further comprising the steps of:
(e) searching monetary transactions of the user using partial textual inputs with supportive keywords; and
(f) presenting search result options based on the searching conducted in step (e).
